(19) United States
(12) Patent Application Publication
(10) Pub. No.: US 2023/0033572 A1
(43) Pub. Date: Feb. 2, 2023

(54) CALL ALERT DEVICE, CALL ALERT SYSTEM, CALL ALERT METHOD, AND CALL ALERT PROGRAM

(71) Applicant: Nippon Telegraph and Telephone Corporation, Tokyo (JP)

(72) Inventors: Shun SUGIMOTO, Musashino-shi, Tokyo (JP); Hiroshi SHIMIZU, Musashino-shi, Tokyo (JP)

(21) Appl. No.: 17/790,389

(22) PCT Filed: Jan. 6, 2020
(86) PCT No.: PCT/JP2020/000033

§ 371 Date: Jun. 30, 2022

(51) Int. Cl. H04M 3/436; H04M 3/58

(52) U.S. Cl. CPC H04M 3/4365; H04M 3/58

(57) ABSTRACT

When an SIP server (24) receives a call signal addressed to a callee side terminal (31), a number conversion history set by an SIP server (22) that has transferred the call signal in a transfer service involved with a number conversion is read from the call signal, and if the number conversion history meets a specific condition, a warning signal is transmitted to the callee side terminal (31) before the call signal is transmitted to the callee side terminal (31). The SIP server (24) transmits a warning signal to the callee side terminal (31) if the number of times of number conversion is equal to or greater than a predetermined number as a specific condition.

### TECHNICAL FIELD

The present invention relates to a call warning apparatus, a call warning system, a call warning method, and a call warning program.

### BACKGROUND ART

In recent years, the number of special scam cases has increased greatly, and “It's me” telephone scams (which are scams in which scammers pretend to be a victim's son saying “It's me”) account for more than half of all scam tricks; therefore, there has been a demand for countermeasures against scams using a telephone. In addition, as IP networks have become widespread, there have been cases where call signals of special scams may sometimes be transmitted on the networks as Session Initiation Protocol (SIP) signals.

PTL 1 describes a method for a communication system that controls calls using SIPs in which guidance is provided to a user who receives a call before end-to-end media connection between a caller terminal and a callee terminal. This allows a callee to operate as requested by the guidance or the like to determine whether a connection is possible.

PTL 2 describes a telephone call system in which evaluation information of a caller terminal is provided to a callee terminal before the callee terminal responds to a call from the caller terminal, and then the callee terminal communicates with the caller terminal. In this way, the callee terminal can appropriately select scenarios to receive a call or disconnect a call according to an instruction of the callee, such as rejecting a call from a caller terminal having a poor evaluation, receiving a call from a caller terminal having a good evaluation.

### CITATION LIST

### Patent Literature

PTL 1: JP 2012-165285 A
PTL 2: JP 2016-163303 A

### SUMMARY OF THE INVENTION

### Technical Problem

In a method of registering attackers on a blacklist in the related art, caller numbers that are identified as having been used in special scams need to be registered in advance and the like. Thus, when an attacker frequently changes caller numbers, the blacklist may become obsolete, which may make it difficult to adequately cope with such special scams. Thus, using other approaches indicating the calling tendencies of special scams needs to be considered, rather than directly indicating the attacker, such as indicating the caller number.

FIG. 7 is a configuration diagram illustrating the concept of a special scam attack passing through multiple service providers.

An example in which an outgoing call from a caller side terminal 11z passes through four SIP servers (an SIP server 21z→an SIP server 22z→an SIP server 23z→an SIP server 24z) to reach the callee number “0422-88-8888” of the callee side terminal 31z is illustrated.

A caller side service provider 21Dz manages the SIP server 21z accommodating the caller side terminal 11z. A connection service provider 22Dz manages the SIP server 22z. A connection service provider 23Dz manages the SIP server 23z. A callee side service provider 24Dz manages the SIP server 24z accommodating the callee side terminal 31z. In addition, a callee number for transfer “03-1111-2222” is set for the SIP server 22z, and a callee number for transfer “03-1111-3333” is set for the SIP server 23z.

Here, attackers often abuse transfer services provided by the SIP servers 22z and 23z to delay identification (tracking) which reveals that the attacker is a special scam caller. In a transfer service, identifying a special scam is difficult because the callee number of a call signal switches from a transfer source number to a transfer destination number.

Thus, it is effective to use a number conversion history at the stage in which the call signal passes through each SIP server as a clue indicating the calling tendency of a special scam. However, such clues have not been used in the related art.

Thus, the present invention has the main task of issuing a suitable warning even when a special scam frequently changes call numbers.

### Means for Solving the Problem

In order to accomplish the task, a call warning apparatus of the present invention has the following features.

According to the present invention, when a call warning apparatus receives a call signal addressed to a callee side terminal, a number conversion history set by a transfer apparatus that has transferred the call signal in a transfer service involved with a number conversion is read from the call signal, and when the number conversion history meets a specific condition, a warning signal is transmitted to the callee side terminal before the call signal is transmitted to the callee side terminal.

### Effects of the Invention

According to the present invention, a suitable warning can be issued even when a special scam frequently changes the call numbers.

### BRIEF DESCRIPTION OF DRAWINGS

FIG. 1 is a configuration diagram of a call warning system according to the present embodiment.

FIG. 2 is a configuration diagram of an SIP server according to the present embodiment.

FIG. 3 is a configuration diagram of hardware of the SIP server according to the present embodiment.

FIG. 4 is a flowchart showing a number conversion history determination process performed by the SIP server according to the present embodiment.

FIG. 5 is a configuration diagram of a call warning system that performs transfer in a case of no response according to the present embodiment.

FIG. 6 is a configuration diagram of a call warning system illustrating a special scam attack in which a collect call service is used according to the present embodiment.

FIG. 7 is a configuration diagram illustrating the concept of a special scam attack passing through multiple service providers.

### DESCRIPTION OF EMBODIMENTS

Hereinafter, an embodiment of the present invention will be described in detail with reference to the drawings.

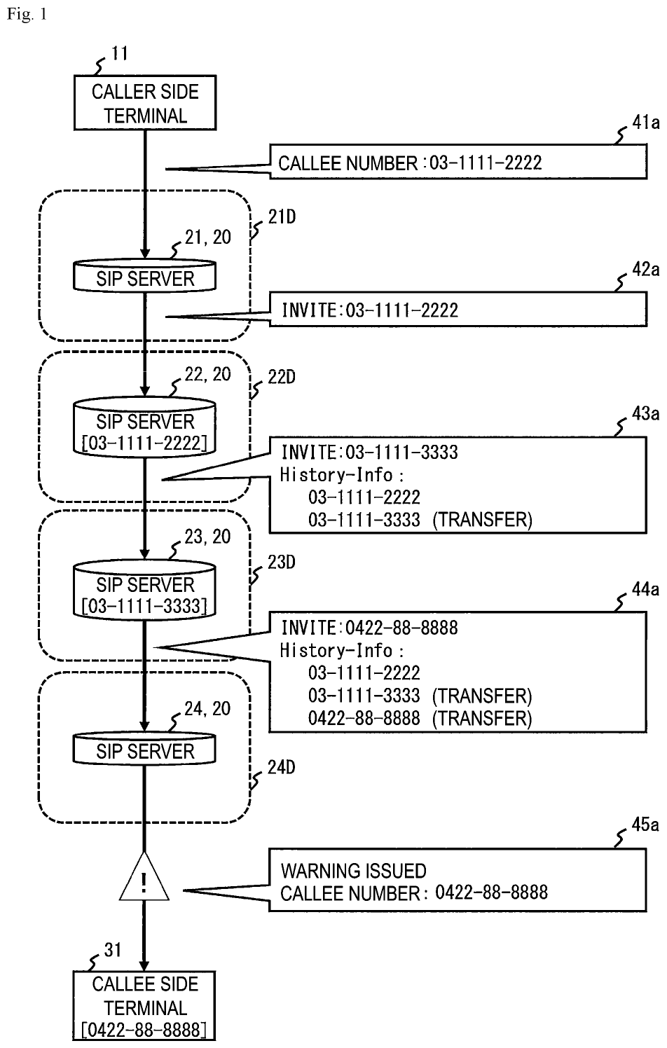

FIG. 1 is a configuration diagram of a call warning system.

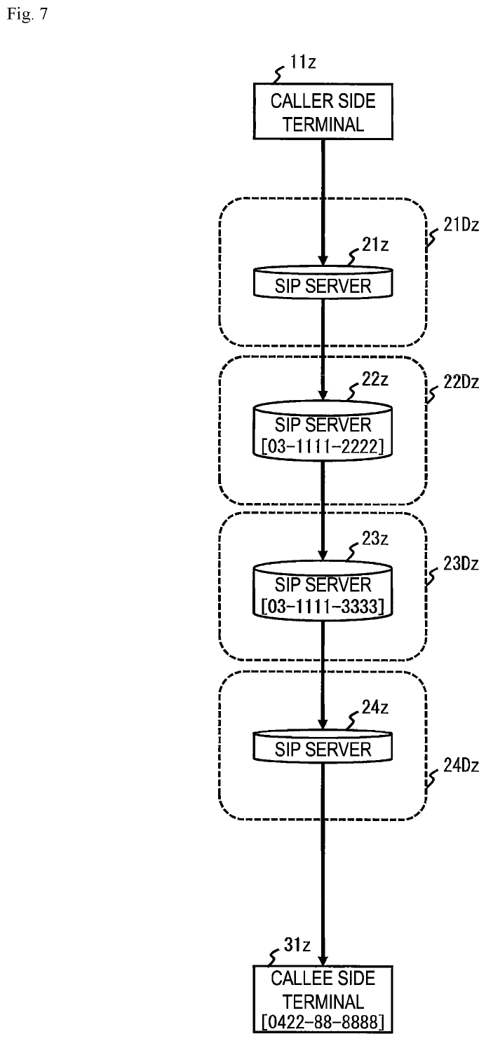

An example in which an outgoing call from a caller side terminal 11 passes through four SIP servers 20 (an SIP server 21→an SIP server 22→an SIP server 23→an SIP server 24) to reach the callee number “0422-88-8888” of a callee side terminal 31 is illustrated, as in FIG. 7. A caller side service provider 21D manages the SIP server 21 covering the caller side terminal 11. A connection service provider 22D manages the SIP server 22. A connection service provider 23D manages the SIP server 23. A callee side service provider 24D manages the SIP server (call warning apparatus) 24 covering the callee side terminal 31. In addition, the SIP server (transfer apparatus) 22 is set with a transfer callee number “03-1111-2222”, and the SIP server (transfer apparatus) 23 is set with the transfer callee number “03-1111-3333”.

The terms “transfer” and “relay” will be used differently in the present specification. For example, it is assumed that the SIP signal (call signal) passes through a first SIP server 20, a second SIP server 20, and a third SIP server 20 in this order. Here, the case in which the second SIP server 20 changes the callee number (destination) of the SIP signal will be referred to as “transfer”, and the case in which the second SIP server 20 does not change the callee number will be referred to as “relay”. For example, the following operation is performed in FIG. 1.
The SIP server 21 relays a received call signal 41a as an SIP signal 42a.
The SIP server 22 transfers the received SIP signal 42a as an SIP signal 43a.
The SIP server 23 transfers the received SIP signal 43a as an SIP signal 44a.
The SIP server 24 relays (calls) the received SIP signal 44a as a call signal 45a.

Then, in a case in which each SIP server 20 transfers an SIP signal, the SIP server 20 sets the transfer source number and the transfer destination number in a number conversion history (History-Info) of the received SIP signal and transmits the SIP signal to the transfer destination. Further, each SIP server 20 is an apparatus that allows notification of the content of History-Info (i.e., a trustworthy apparatus) and is only required to register an SIP server 20 that is another apparatus in the Privacy header of the SIP signal (not illustrated).

Here, because It's me scams tend to abuse the transfer service, the SIP server 24 is designed to transmit guidance (a warning signal) to give a warning to the callee side terminal 31 before starting a call of the call signal 45a when the content of the number conversion history of the SIP signal 44a that has reached the SIP server 24 is unnatural.

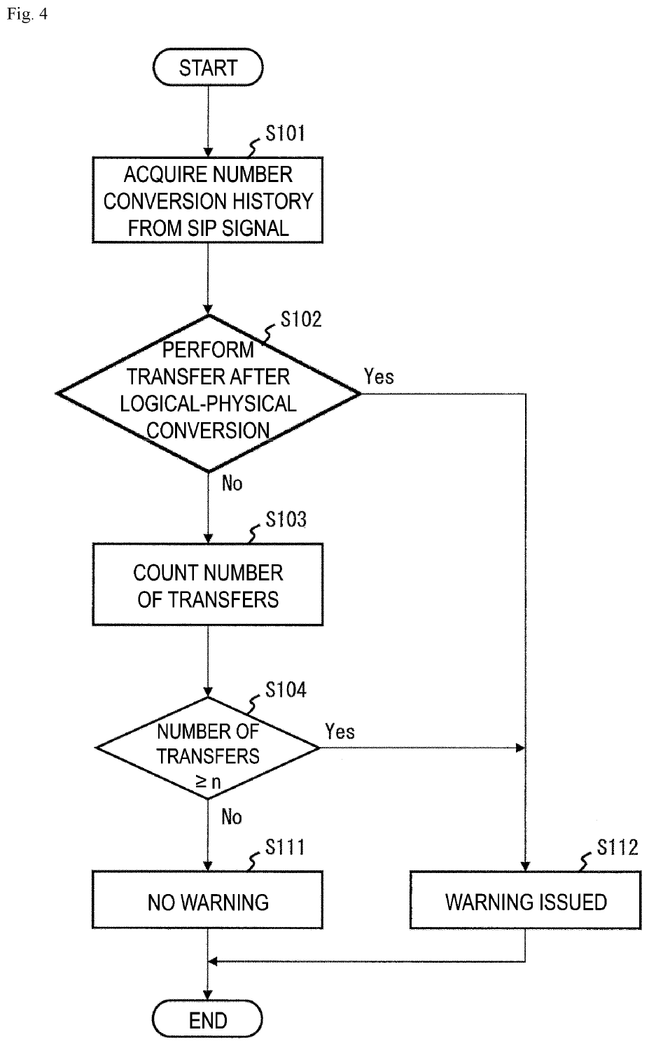

Further, the number conversion history is information that is distributed to service providers and is information that cannot be removed by an attacker from outside of the service providers in order to spoil the evidence. Details of the process to determine whether to transmit a warning based on the content of the number conversion history are described below in the flowchart of FIG. 4. In addition, a specific SIP procedure to transmit guidance before starting a call is described in PTL 1.

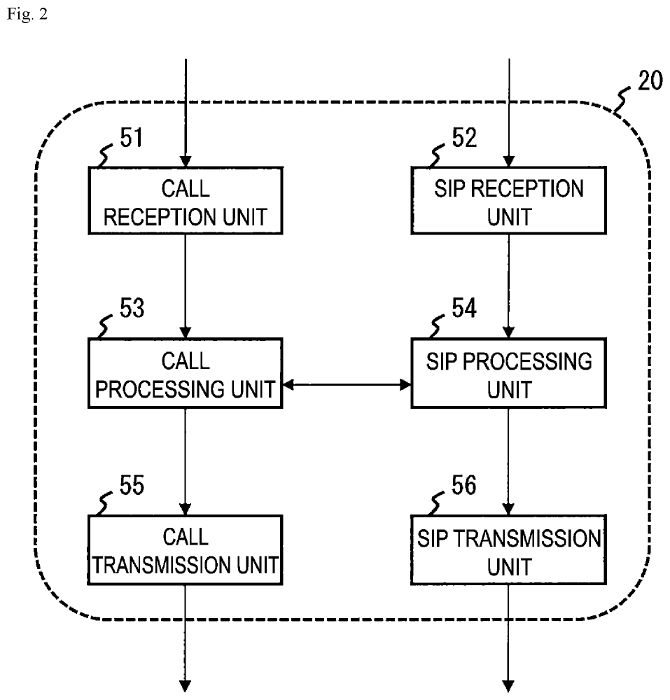

FIG. 2 is a configuration diagram of an SIP server 20.

The SIP server 20 includes a call reception unit 51, an SIP reception unit 52, a call processing unit 53, an SIP processing unit 54, a call transmission unit 55, and an SIP transmission unit 56. Hereinafter, processing of the SIP server 20 will be described along the details of each signal (the call signals 41a and 45a, and the SIP signals 42a to 44a) in FIG. 1.

First, the SIP server 21 of the caller side service provider 21D will be described. The call reception unit 51 of the SIP server 21 receives the call signal 41a from the caller side terminal 11. The call signal 41a includes the callee number “03-1111-2222” of the transfer service provided by the SIP server 22.

The call processing unit 53 recognizes that the callee number of the received call signal 41a is addressed to another service provider. The SIP processing unit 54 creates the SIP signal 42a including the callee number of the call signal 41a as INVITE. The SIP transmission unit 56 transmits the created SIP signal 42a to the SIP server 22.

Next, the SIP server 22 of the connection service provider 22D will be described. The SIP reception unit 52 of the SIP server 22 receives the SIP signal 42a from the SIP server 21. The SIP processing unit 54 acquires the new callee number “03-1111-3333” of the SIP server 23 which is another transfer destination of the received SIP signal 42a from set data of the transfer service based on the callee number “03-1111-2222” of the received SIP signal 42a. The SIP processing unit 54 creates the SIP signal 43a from the SIP signal 42a through the following processing.
The callee number (INVITE) “03-1111-2222” of the transfer source is replaced with “03-1111-3333” of the transfer destination.
A new History-Info header is created and “03-1111-2222” of the transfer source and “03-1111-3333” of the transfer destination are added to the History-Info header. Further, the reason for the number conversion (transfer) to “03-1111-3333” of the transfer destination is also added.

The SIP transmission unit 56 transfers the created SIP signal 43a to the SIP server 23.

Further, although the content of the History-Info header in the SIP signal 43a are described in FIG. 1 as being abbreviated as “03-1111-2222, 03-1111-3333 (transfer)”, the real content is text data as follows.
First row (transfer source)=<sip: 0311112222@exampleC.com; user=phone>; index=1 Here, “0311112222” after “sip:” in the first row indicates the callee number of the SIP server 22, “exampleC.com” indicates the domain of the connection service provider 22D, and “index” indicates the serial number of each entry.
Second row (transfer destination)=<sip: 0311113333@exampleB.com; user=phone; cause=302>; index=1.1; mp=1

Here, “cause=302” in the second row indicates the reason for the number conversion (here, a normal transfer), and “mp” indicates the serial number of the entry of the conversion source.

In addition, the SIP server 23 of the connection service provider 23D will be described. The SIP reception unit 52 of the SIP server 23 receives the SIP signal 43a from the SIP server 22. The SIP processing unit 54 acquires the new callee number “0422-88-8888” of the callee side terminal 31 that is the transfer destination of the received SIP signal 43a from set data of the transfer service based on the callee number “03-1111-3333” of the SIP signal 43a.

The SIP processing unit 54 creates the SIP signal 44a from the SIP signal 43a through the following processing.
The callee number (INVITE) “03-1111-3333” of the transfer source is replaced with “0422-88-8888” of the transfer destination.
“0422-88-8888” of the transfer destination and the reason for the number conversion (transfer) are associated and added to the History-Info header.

Further, the following third row is added to the content of the History-Info header in the SIP signal 44a.
Third row (the second transfer destination)=<sip: 04228888888@exampleA.com; user=phone; cause=302>; index=1.1.1; mp=1.1 The SIP transmission unit 56 transmits the created SIP signal 44a to the SIP server 24 directed to the callee side terminal 31 of the transfer destination.

Next, the SIP server 24 will be described.

The SIP reception unit 52 of the SIP server 24 receives the SIP signal 44a from the SIP server 23. The SIP processing unit 54 recognizes that the callee number of the received SIP signal 44a is of the callee side terminal 31 covered by the SIP server 24.

Here, the SIP processing unit 54 performs the determination process of FIG. 4 to recognize that the content of the History-Info header in the SIP signal 44a is unnatural and a warning is needed. The call processing unit 53 creates the call signal 45a with the extracted callee number “0422-88-8888” stated in INVITE of the received SIP signal 44a. Then, the call transmission unit 55 transmits warning guidance to the callee side terminal 31 before starting a call of the call signal 45a.

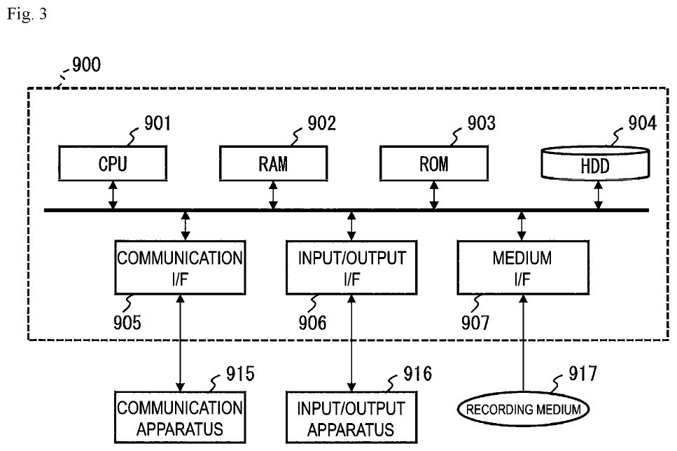

FIG. 3 is a hardware configuration diagram of the SIP server 20.

The SIP server 20 is configured as a computer 900 including a CPU 901, a RAM 902, a ROM 903, an HDD 904, a communication I/F 905, an input/output I/F 906, and a medium I/F 907. The communication I/F 905 is connected to an external communication apparatus 915. The input/output I/F 906 is connected to an input/output apparatus 916. The medium I/F 907 reads and writes data from a recording medium 917. Further, the CPU 901 controls the processing units by executing a program (also referred to as an application or an app that is an abbreviation thereof) read into the RAM 902. In addition, the program can also be distributed through a communication line or recorded and distributed on the recording medium 917 such as a CD-ROM.

FIG. 4 is a flowchart showing a number conversion history determination process performed by the SIP server 24. In this flowchart, the SIP server 24 determines that a warning is needed when a number conversion history meets a particular condition.

The SIP server 24 acquires the number conversion history from the received SIP signal (S101) and determines whether a transfer after a logical-physical conversion has been performed in the number conversion history (the particular condition) (S102). The logical-physical conversion is a process of converting a logical number into a physical number. When the answer is YES in S102, it is determined that a warning is needed before a call is made to the callee side terminal 31 (S112).

When the answer is NO in S102, the SIP server 24 counts the number of transfers from the number conversion history of S101 (S103). Here, the SIP server 24 may count the number of transfers as is, regardless of the conversion cause, or may count the number of transfers after weighting the conversion cause of each transfer.
The SIP server 24 counts the number of transfers as one transfer when the reason for the number conversion is a normal transfer (in the event of response) (cause=302). In addition, different weights may be given to a case of response by a human and a case of automatic response by a machine.
The SIP server 24 assumes that the call is less likely to be used for a scam when the reason for the number conversion is a transfer in a case of no response (cause=408) and counts the number of transfers as 0.5.

Then, the SIP server 24 determines that a warning is needed (S112) before a call is made to the callee side terminal 31 when the number of transfers of S103 is equal to or greater than a predetermined number of times (n times, for example, n=2) (the particular condition) (YES in S104). The SIP server 24 determines that no warning is needed if the answer in S104 is NO (S111).

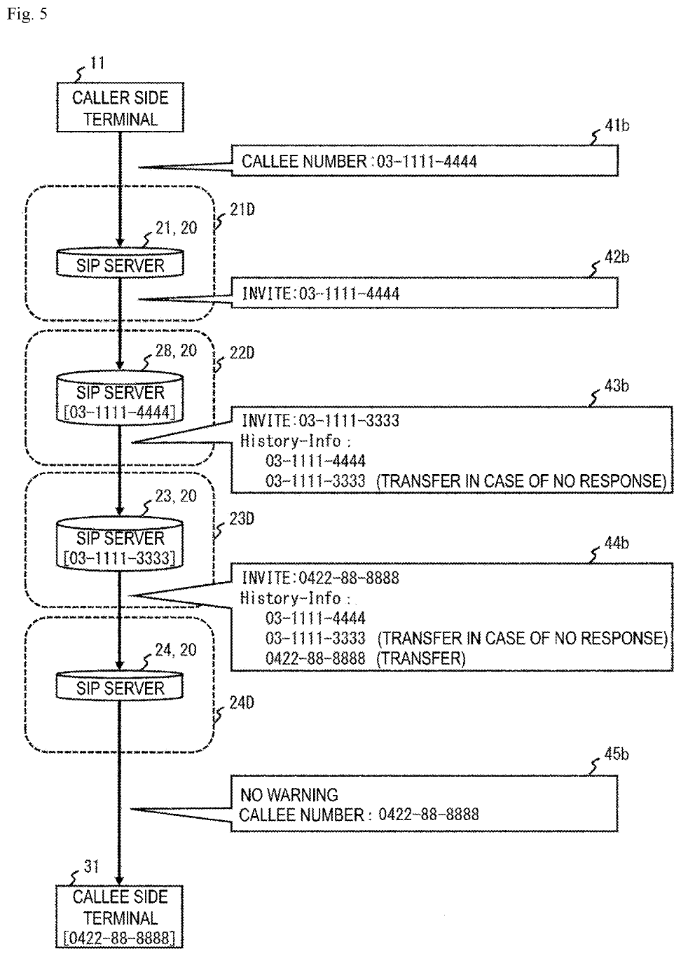

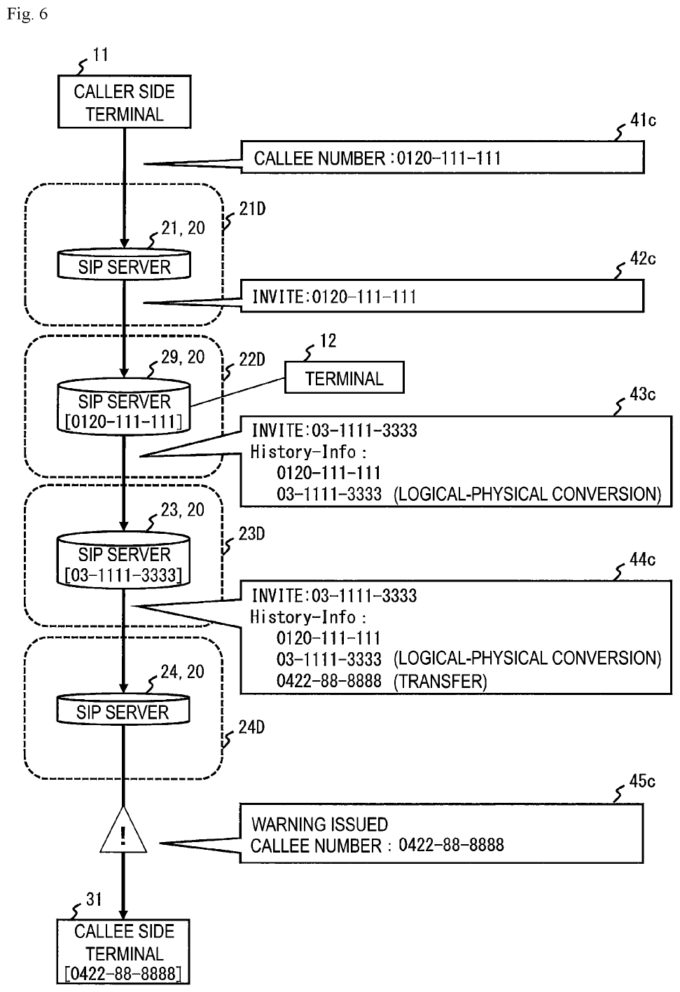

A specific case in which the determination process shown in FIG. 4 is used will be described below with reference to FIGS. 5 and 6.

FIG. 5 is a configuration diagram of a call warning system in which a transfer in a case of no response is performed.

Although the system configuration is roughly the same in FIGS. 1 and 5, regarding the second SIP server from the upstream side, the SIP server 22 that has carried out the transfer service in a case of a response is replaced with the SIP server 28 that has carried out the transfer service in a case of no response. That is, the transfer number “03-1111-2222” of the SIP server 22 is replaced with the transfer number “03-1111-4444” of the SIP server 28.

Furthermore, regarding the signal flowing from the caller side terminal 11 (upstream side) to the callee side terminal 31 (downstream side), “the call signal 41a→the SIP signal 42a→the SIP signal 43a→the SIP signal 44a→the call signal 45a” of FIG. 1 is replaced with “a call signal 41b→an SIP signal 42b→an SIP signal 43b→an SIP signal 44b→a call signal 45b” of FIG. 5.

Further, the content of the History-Info header in the SIP signal 43b created by the SIP server 28 is text data as follows.
First row (transfer source)=<sip: 0311114444@exampleC.com; user=phone>; index=1
Second row (transfer destination)=<sip: 0311113333@exampleB.com; user=phone; cause=408>; index=1.1; mp=1

Here, “cause=408” in the second row indicates the reason for the number conversion (here, a transfer in a case of no response).

The History-Info header of the SIP signal 44b received by the SIP server 24 includes one normal transfer (counted as one in S103 of FIG. 4) and one transfer in a case of no response (count as 0.5). Thus, the SIP server 24 determines that no warning is needed (S111) because the total number of transfers is 1.5 which is less than two (NO in S104).

FIG. 6 is a configuration diagram of a call warning system illustrating a special scam attack using a collect call service.

Although the system configuration is roughly the same in FIGS. 1 and 6, regarding the second SIP server from the upstream side, the SIP server 22 that performs a normal transfer service is replaced with an SIP server 29 that performs a logical-physical conversion in a collect call service. That is, the transfer number “03-1111-2222” of the SIP server 22 is replaced with the toll-free number “0120-111-111” of the SIP server 29.

Furthermore, regarding the signal flowing from the caller side terminal 11 (upstream side) to the callee side terminal 31 (downstream side), “the call signal 41a→the SIP signal 42a→the SIP signal 43a→the SIP signal 44a→the call signal 45a” of FIG. 1 is replaced with “a call signal 41c→an SIP signal 42c→an SIP signal 43c→an SIP signal 44c→a call signal 45c” of FIG. 6.

Further, the content of the History-Info header in the SIP signal 43c created by the SIP server 29 is text data as follows.
First row (transfer source)=<sip: 0120111111@exampleC.com; user=phone>; index=1
Second row (transfer destination)=<sip: 0311113333@exampleB.com; user=phone; cause=380>; index=1.1; mp=1

Here, “cause=380” in the second row indicates the reason for the number conversion (here, the logical-physical conversion).

In this way, the SIP server 24 determines that a warning is needed before a call is made to the callee side terminal 31 (S112) because the History-Info header of the SIP signal 44c includes “0422-88-8888 (transfer)” subsequent to “03-1111-3333 (logical-physical conversion)” (YES in S102 of FIG. 4).

Further, a case in which a call is made to a reception desk such as a terminal 12 directly connected to the SIP server 29 and transferred immediately after the logical-physical conversion in the collect call service provided by the SIP server 29, or the like, is rare. Thus, it is assumed that the case of a call transferred after the logical-physical conversion is likely to be of an ill-intended transfer and a warning will be given.

In addition, a warning issued due to “a transfer after a logical-physical conversion” is an example of a policy that defines whether a warning is to be issued when the order of reasons for the number conversion matches a particular pattern. Thus, the administrator of the SIP server 24 may register a new specific pattern representing the tendency of special scam attacks in the SIP server 24 when a new specific pattern is discovered by analyzing traffic, or the like, in order to improve the warning accuracy.

Effects

According to the present invention, when the SIP server 24 receives a call signal addressed to the callee side terminal 31 as a transmission destination, a number conversion history set by the SIP server 22 that has transferred the call signal in the transfer service involved with a number conversion is read from the call signal, and if the number conversion history meets a specific condition, a warning signal is transmitted to the callee side terminal 31 before the call signal is transmitted to the callee side terminal 31.

This allows a warning to be given to a callee without using previously obtained attacker information (blacklist), and thus countermeasures can be taken against a trick of frequently changing numbers by giving a warning in real time.

According to the present invention, the SIP server 24 transmits a warning signal to the callee side terminal 31 if the number of times of number conversion is equal to or greater than a predetermined number as a specific condition.

Thus, ill-intention can be assumed when a transfer service is excessively used even though it is a normal service, and a suitable warning can be issued.

According to the present invention, the SIP server 24 counts the number of times of number conversion based on the weight associated with each conversion cause.

Thus, it is possible to avoid excessively issuing warnings to call signals that are less likely to be used in scams, by counting the number of transfers as 0.5 when, for example, the reason for the number conversion is a transfer in a case of no response (cause=408).

According to the present invention, the SIP server 24 transmits a warning signal to the callee side terminal 31 when another transfer occurs after the conversion from the logical number into the physical number takes place as a specific condition.

This allows a suitable warning to be issued to a call signal for unauthorized use of a collect call service such as toll-free numbers. Further, normal call signals tend to be used to make a call to a reception desk of the terminal 12 or the like directly connected to the SIP server 29 immediately after the logical-physical conversion of toll-free numbers.

The present invention is a call warning system including the SIP server 24 and the SIP servers 22 and 23 in which, when a callee number of a received call signal is a callee number of the transfer service provided by the SIP servers 22 and 23, the servers convert the number into the callee number of the transfer destination, and transfer a call signal in which the converted callee number has been added to a number conversion history to the transfer destination.

Thus, the SIP server 24 can trust the number conversion history from the SIP servers 22 and 23 that the call signal has passed through and issue a suitable warning.

### REFERENCE SIGNS LIST

11 Caller side terminal
20, 21 SIP server
22, 23 SIP server (transfer apparatus)
24 SIP server (call warning apparatus)
31 Callee side terminal
41a, 45a Call signal
42a, 43a, 44a SIP signal (call signal)
51 Call reception unit
52 SIP reception unit
53 Call processing unit
54 SIP processing unit
55 Call transmission unit
56 SIP transmission unit

1. A call warning apparatus comprising a processor, a receiver, and a transmitter, wherein
when the receiver receives a call signal addressed to a callee side terminal, the processor reads from the call signal a number conversion history set by a transfer apparatus that transfers the call signal by a transfer service with number conversion, and when the number conversion history meets a specific condition, the transmitter transmits a warning signal to the callee side terminal before the call signal is transmitted to the callee side terminal.

2. The call warning apparatus according to claim 1, wherein
the transmitter transmits a warning signal to the callee side terminal when the number of times of the number conversion is equal to or greater than a predetermined number of times as the specific condition.

3. The call warning apparatus according to claim 2, wherein
the processor counts the number of times of the number conversion in accordance with a weight associated with a conversion cause.

4. The call warning apparatus according to claim 1, wherein
the transmitter transmits a warning signal to the callee side terminal when another transfer occurs after conversion from a logical number into a physical number takes place as the specific condition.

5. The call warning apparatus according to claim 1, wherein
when a callee number of a call signal received is a callee number of a transfer service provided by the transfer apparatus, the transfer apparatus converts the callee number of the call signal into a callee number of a transfer destination and transfers a call signal in which the callee number converted is added to a number conversion history to the transfer destination.

6. A call warning method, comprising:
by a call warning apparatus comprising at least one processor:
when a call signal addressed to a callee side terminal is received, reading from the call signal a number conversion history set by a transfer apparatus that transfers the call signal by a transfer service with number conversion; and
when the number conversion history meets a specific condition, transmitting a warning signal to the callee side terminal before the call signal is transmitted to the callee side terminal.

7. A non-transitory computer readable medium storing instructions of a call warning program that, upon execution, cause a computer serving as a call warning apparatus to perform operations comprising:
when a call signal addressed to a callee side terminal is received, reading from the call signal a number conversion history set by a transfer apparatus that transfers the call signal by a transfer service with number conversion; and
when the number conversion history meets a specific condition, transmitting a warning signal to the callee side terminal before the call signal is transmitted to the callee side terminal.
